(19) United States
(12) Patent Application Publication
(10) Pub. No.: US 2022/0198315 A1
(43) Pub. Date: Jun. 23, 2022

(54) METHOD FOR DENOISING QUANTUM DEVICE, ELECTRONIC DEVICE, AND COMPUTER-READABLE MEDIUM

(71) Applicant: Beijing Baidu Netcom Science Technology Co., Ltd., Beijing (CN)

(72) Inventors: Kun Wang, Beijing (CN); Yuao Chen, Beijing (CN); Xin Wang, Beijing (CN)

(21) Appl. No.: 17/654,150

(22) Filed: Mar. 9, 2022

(30) Foreign Application Priority Data
Jun. 10, 2021 (CN) 202110647964.5

(51) Int. Cl. G06N 10/70; G06N 10/20

(52) U.S. Cl. CPC G06N 10/70; G06N 10/20

(57) ABSTRACT

The present disclosure provides a method for denoising a quantum device, and relates to the technical fields, such as quantum circuits, quantum algorithms, and quantum calibration. A specific implementation includes: acquiring a noise channel of an actual quantum device; determining a truncation coefficient based on the noise channel; running the actual quantum device to generate an intermediate quantum state; performing a first iteration of applying the noise channel to the intermediate quantum state for the number of times, the number being equal to a value of the truncation coefficient, each applying stage of the first iteration being performed based on a result of a previous applying stage of the first iteration; and computing a zero-noise expected value of an ideal quantum device corresponding to the actual quantum device based on the intermediate quantum state and a resultant quantum state obtained through each applying stage of the first iteration.

### CROSS-REFERENCE TO RELATED APPLICATIONS

The present application claims the priority of Chinese Patent Application No. 202110647964.5, titled “METHOD AND APPARATUS FOR DENOISING QUANTUM DEVICE, ELECTRONIC DEVICE AND COMPUTER-READABLE MEDIUM”, filed on Jun. 10, 2021, the content of which is incorporated herein by reference in its entirety.

### TECHNICAL FIELD

The present disclosure relates to the technical field of quantum computing, specifically relates to the technical fields, such as quantum circuits, quantum algorithms, and quantum calibration, and more specifically relates to a method for denoising a quantum device, an electronic device, and a computer-readable storage medium.

### BACKGROUND

With the rapid development of quantum computer technologies, the golden age of quantum computing is coming. However, the noise problems in quantum computing are unavoidable in the future.

### SUMMARY

A method for denoising a quantum device an electronic device, and a computer-readable medium are provided.

According to a first aspect, a method for denoising a quantum device is provided, including: acquiring a noise channel of an actual quantum device; determining a truncation coefficient based on the noise channel, the truncation coefficient being used for characterizing the number of expanded items of a Neumann series of the noise channel at a current error tolerance; running the actual quantum device to generate an intermediate quantum state; performing a first iteration of applying the noise channel to the intermediate quantum state for the number of times, the number being equal to a value of the truncation coefficient, each applying stage of the first iteration being performed based on a result of a previous applying stage of the first iteration; and computing a zero-noise expected value of an ideal quantum device corresponding to the actual quantum device based on the intermediate quantum state and a resultant quantum state obtained through each applying stage of the first iteration.

According to a second aspect, an electronic device is provided. The electronic device includes: at least one processor; and a memory communicatively connected to the at least one processor; where the memory stores instructions executable by the at least one processor, and the instructions, when executed by the at least one processor, cause the at least one processor to execute the method according to any one implementation in the first aspect.

According to a third aspect, a non-transitory computer-readable storage medium storing computer instructions is provided, where the computer instructions are used for causing a computer to execute the method according to any one implementation in the first aspect.

It should be understood that contents described in the SUMMARY are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution, and do not constitute any limitation to the present disclosure.

FIG. 1 is a flowchart of a method for denoising a quantum device according to an embodiment of the present disclosure;

FIG. 2 is a schematic structural diagram of an iterative function on an intermediate quantum state according to an embodiment of the present disclosure;

FIG. 3 is a flowchart of a method for obtaining a truncation coefficient according to an embodiment of the present disclosure;

FIG. 4 is a schematic diagram of a noisy expected value and a zero-noise expected value varying with a noise parameter according to an embodiment of the present disclosure;

FIG. 5 is a schematic structural diagram of an apparatus for denoising a quantum device according to an embodiment of the present disclosure; and

FIG. 6 is a block diagram of an electronic device configured to implement the method for denoising a quantum device according to embodiments of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description.

In order to better understand the method provided in the embodiments of the present disclosure, relevant concepts involved in the embodiments of the present disclosure are explained below.

A quantum state is a motion state of microscopic particles described by a plurality of quantum numbers.

Classical computer or conventional computer is a computer that uses classical physics as the theoretical basis for information processing. The classical computer stores data or programs using binary data bits that are most easily implemented in classical physics, where each binary data bit is denoted by 0 or 1, is referred to as a bit, and serves as the smallest information unit. The classical computer itself has following inevitable weaknesses: the first one is the most basic limitation of energy consumption in the computing process, the minimum energy required for a logic element or a storage unit should be several times greater than kT; the second one is the information entropy and heating energy consumption; and the third one is that when a wiring density of a computer chip is very large, the smaller a uncertainty of an electronic position is, the greater a uncertainty of a momentum is, according to the Heisenberg uncertainty relationship, and when electrons are no longer bound, there will be a quantum interference effect, and this effect will even destroy the performance of the chip.

A quantum computer is a type of physical device that performs high-speed mathematical and logical operations, and stores and processes quantum information in accordance with the properties and laws of quantum mechanics. When a certain device processes and computes quantum information and runs a quantum algorithm, the certain device is a quantum computer. The quantum computer achieves a new mode of information processing following the unique laws of quantum dynamics. For parallel processing of computing problems, the quantum computer has an absolute advantage in speed over the classical computer. The transformation implemented by the quantum computer for each superimposed component is equivalent to a classical computation. All these classical computations are completed at the same time, and superimposed according to a probability amplitude to give an output result of the quantum computer. These computations are referred to as parallel quantum computing. Parallel quantum processing greatly improves the efficiency of the quantum computer, for example, the quantum computer can complete a task that cannot be done by the classical computer, such as the factorization of a very large natural number. Quantum correlation is essentially used in all ultrafast quantum algorithms. Therefore, the use of the quantum state in replacement of the classical state for parallel quantum computing can achieve computing speed and information processing functions that the classical computer cannot achieve, whilst saving a lot of computing resources.

Chemical simulation means to find an eigenstate capable of reflecting a real chemical system by mapping a Hamiltonian of a real chemical system to a physically operable Hamiltonian, and then modulating the parameters and evolution time. When simulating a chemical system with n electrons on the classical computer, solving a 2ⁿ-dimensional (n>1) Schrödinger equation is involved, and the number of computations increases exponentially with the increase of the number of electrons in the system. Therefore, the classical computer plays a very limited role in chemical simulation problems. To break through this bottleneck, it is necessary to rely on the powerful computing power of the quantum computer.

A VQE (Variational Quantum Eigensolver) algorithm, as an efficient quantum algorithm for chemical simulation on quantum hardware, is one of the most promising applications of quantum computers in the near future, and opens up many entirely new fields of chemical researches. However, the noise rates of quantum circuits of quantum computers obviously limit the ability of VQE at present. Therefore, it is necessary to well deal with the noise problems of quantum circuits. Embodiments of the present disclosure may be used to remove the noises of the quantum circuits in the VQE algorithm, and therefore have important applications in the field of chemical simulation.

The method for denoising a quantum device provided in embodiments of the present disclosure first acquire a noise channel of an actual quantum device; then determine a truncation coefficient based on the noise channel, the truncation coefficient being used for characterizing the number of expanded items of a Neumann series of the noise channel at a current error tolerance; then run the actual quantum device to generate an intermediate quantum state; then perform a first iteration of applying the noise channel on the intermediate quantum state for the number of times, the number being equal to a value of the truncation coefficient, each applying stage of the first iteration being performed based on a result of a previous applying stage of the first iteration; and finally compute a zero-noise expected value of an ideal quantum device corresponding to the actual quantum device based on the intermediate quantum state and a resultant quantum state obtained through each applying stage of the first iteration. The embodiments of the present disclosure reversely infer an ideal situation where the actual quantum device is noise-free using a plurality of noises of different levels. The embodiments of the present disclosure are suitable for any quantum device capable of generating a quantum state and do not rely on a means, such as a noise model, thus providing better universality. The present embodiment does not rely on qubit data and thus provides better expansibility, and can be widely used in the quantum device. The present embodiment can compute a zero-noise expected value of an ideal quantum device corresponding to the quantum device, as long as a noise channel of a quantum device is maintained within a reasonable range, thereby providing high practicability.

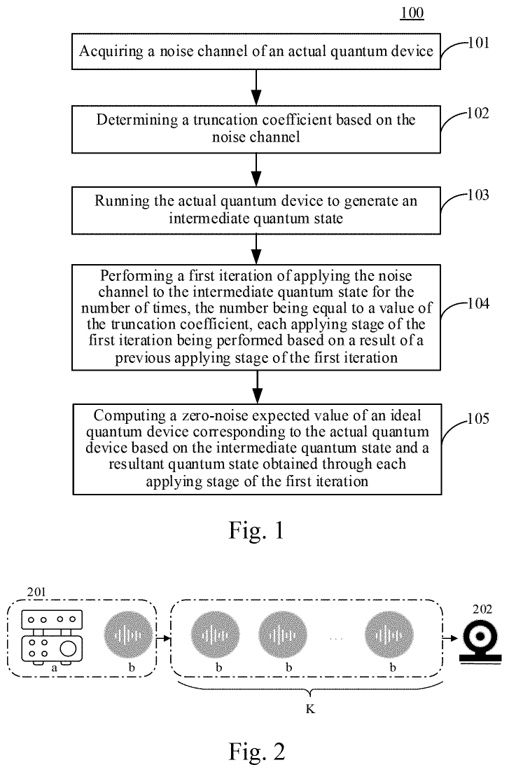

FIG. 1 shows a process 100 of a method for denoising a quantum device according to an embodiment of the present disclosure. The method for denoising a quantum device includes the following steps:

Step 101: acquiring a noise channel of an actual quantum device.

In the present embodiment, the method for denoising a quantum device may be applied to an electronic device such as a recent quantum device, such as a quantum computer. In the present embodiment, compared with a conventional quantum computer, the quantum computer used in the present embodiment may include: a memory, a classical processor, a quantum processor, and a program stored in a memory and capable of being run on the classical processor and the quantum processor. The classical processor executes, when running the program in combination with the quantum processor, the method for denoising a quantum device according to embodiments of the present disclosure.

In the present embodiment, the actual quantum device is an actually existing quantum device, and is alternatively an experimentally implementable quantum device. Due to the existence of a quantum noise in the actual quantum device (i.e., the actual quantum device is not ideal, but has the quantum noise), the actual quantum device is composed of an ideal quantum device and the noise channel, where the ideal quantum device is a part of the actual quantum device that does not contain a noise. Invoking the ideal quantum device will generate an ideal quantum state ρ, but the ideal quantum state will inevitably pass through a noise channel [symbol] , the system state is evolved into [symbol] (ρ), and a measuring device measures [symbol] (ρ), because of the existence of the quantum noise, the measurement result obtained by the measuring device deviates from the actual value. The actual problem solved by the method for denoising a quantum device and the apparatus for denoising a quantum device provided in the present embodiment is how to reduce or even eliminate the influence of the quantum noise on an expectation value, to obtain an unbiased estimate of a zero-noise expected value.

Mathematically, one of the core computing processes of VQE is to estimate an expectation value Tr[Oρ], where ρ is an n-qubit quantum state generated by the ideal quantum device, and an observation operator symbol O of the n-qubit quantum state is a symbol of an observation operator of a Hamiltonian of a real chemical system mapped to a physically operable Hamilton. It should be noted that the above process is a general form of extracting classical information by quantum computing, and the VQE algorithm may have a wide range of applications, instead of being limited to the contents described in the present disclosure.

In the present embodiment, an observation operator reflected by the observation operator symbol O corresponds to an operator of interest in an experiment. For example, a photon is a quantum state, and has many different properties. If a spin property of a photon is to be measured, it is necessary to use a “spin” observation operator for detection.

In order to better describe the solutions provided in the embodiments of the present disclosure, specific description will be provided by applying the method for denoising a quantum device to an electronic device in the following description.

Step 102: determining a truncation coefficient based on the noise channel.

The truncation coefficient is used for characterizing the number of expanded items of a Neumann series of the noise channel at a current error tolerance.

In the present embodiment, the noise channel is a most basic physically implementable quantum operation. Through a corresponding quantum analysis method, a noise behavior of the actual quantum device may be obtained. In the present embodiment, the noise channel may be a Pauli transfer matrix obtained by the quantum analysis method.

In some alternative implementations of the present embodiment, the acquiring the noise channel of the actual quantum device includes: acquiring the noise channel of the actual quantum device by a quantum process tomography or a quantum gate set tomography. However, it should be understood that other quantum analysis methods may also be used for acquiring the noise channel of the actual quantum device. This is not limited here.

When controlling an unknown quantum computer system, it is necessary to first determine its dynamic characteristics. When studying dynamic characteristics of any system, it is necessary to determine its mathematical description. Quantum tomography is a method of obtaining a mathematical description of an unknown quantum system by preparing a series of appropriate quantum states, and measuring and estimating corresponding outputted quantum states of the series of appropriate quantum states. For example, the quantum process tomography is a commonly used method for experimentally determining an unknown quantum operation, and the quantum process tomography may not only be used for fully characterizing dynamic characteristics of a quantum computer system, but also be used for characterizing the performance of a specific quantum gate or a channel for quantum communication or determining the type and amplitude of a noise in a quantum computer system. Through the quantum tomography technology, various parameters reflecting properties of the quantum computer system may be directly or indirectly computed.

A noise in quantum computing cannot be quantified by scalars, which is one of the reasons why noise processing is difficult. In the present embodiment, a value of the noise of the actual quantum device is qualitatively (not quantitatively) characterized by the number of times of use of the noise channel. The more the number of times of use of the noise channel is, the louder the introduced noise is. The number of times of use of the noise channel may be reflected by the truncation coefficient, which is related to the noise channel and the error tolerance. With different noise channels or/and different error tolerances, the obtained truncation coefficients are different.

In the present embodiment, the truncation coefficient may be obtained by many approaches. For example, after the noise channel is obtained, Neumann series expansion is performed on the noise channel to obtain a Neumann series expansion equation of the noise channel. The number of expanded items that can reflect the Neumann series expansion equation, i.e., the truncation coefficient, is determined based on an energy state reflected by the Neumann series expansion equation, the current error tolerance and a current observation operator.

Assuming that a spectral radius of a noise channel A is smaller than 1, the following expansion equation may be obtained using the Neumann series:

A⁻¹=Σₖ₌₀^{∞}(I−A)^{k}=Σₖ₌₀^{K}c_{K}(k)A^{k}+O((I−A)^{K+1}) (1)

In the equation (1), I denotes a unit matrix, K is the number of expanded items (i.e., the truncation coefficient) selected based on the current error tolerance, and c_{K}(k) is a coefficient of an expanded item A^{k} with a mathematical expression of:

$${c}_{K} ( k ) = {( - 1 )}^{k} ( \begin{matrix}K + 1 \\ k + 1\end{matrix} )$$

In the equation (2),

$$( \begin{matrix}n \\ k\end{matrix} )$$

denotes a binomial coefficient. Assuming that the truncation coefficient K=5, the corresponding expansion equation is:

A⁻¹=6I−15A+20A²−15A³+6A⁴−A⁵+O((I−A)⁶)

That is, the first 6 items 6I, −15A, 20A², −15A³, 6A⁴, −A⁵ of the expansion equation are used to approximate a target matrix A⁻¹.

In some alternative implementations of the present embodiment, an equation of the truncation coefficient is obtained through a plurality of times of experiments and computations as follows:

$$K \geq ⌈ \frac{log ɛ - log ‖ ⪡ O ‖ {\vert}_{∞}}{log {‖ I - [ N ] ‖}_{∞}} - 1 ⌉ \qquad ( 3 )$$

In the equation (3), O is an observation operator symbol, <<O| is a Pauli transfer matrix of O, I is a unit matrix, ∥ ∥_{∞} represents an infinite norm, ┌.┐ represents rounding up, [symbol] is the noise channel, [ [symbol] ] is a Pauli transfer matrix of [symbol] , and ε is the current error tolerance.

In the present embodiment, through the computation equation of the truncation coefficient obtained through the experiments and computations, a zero-noise expected value of the ideal device corresponding to the actual quantum device can be quickly and easily obtained, thereby providing a reliable data basis for obtaining a noise-free quantum state of the actual quantum device.

Step 103: running the actual quantum device to generate an intermediate quantum state.

In the present embodiment, the ideal quantum device is an assumed quantum device i.e., an actual quantum device in a noise-free condition. Therefore, it is impossible to obtain a noise-free quantum state by running the ideal quantum device during an experiment. In order to obtain the zero-noise expected value of the ideal quantum device, the actual quantum device may be run once to obtain the intermediate quantum state, and then the zero-noise expected value of the ideal quantum device corresponding to the actual quantum device may be computed based on the intermediate quantum state.

Specifically, as shown in FIG. 2, an actual quantum device 201 is run once, which is equivalent to invoking an ideal quantum device a to generate a quantum state and the quantum state passing through a noise channel b to obtain a noise intermediate quantum state. The intermediate quantum state repeatedly uses the same noise channel b for a total of K times. After resultant quantum states obtained through each use of the noise channel b are summarized, a summarized result is measured by a measuring device 202, and the zero-noise expected value of the ideal quantum device a is computed using a classical computer based on the measured result.

Step 104: performing a first iteration of applying the noise channel to the intermediate quantum state for the number of times, the number being equal to a value of the truncation coefficient, each applying stage of the first iteration being performed based on a result of a previous applying stage of the first iteration.

In the present embodiment, a truncation coefficient K determines the number of times of applying the noise channel, and the performing a first iteration of applying the noise channel to the intermediate quantum state for K times, K being equal to the value of the truncation coefficient includes:

For each integer k (k∈{1, . . . , K}) in an integer set {1, . . . , K}, the noise channel is applied for k times to the intermediate quantum state to obtain a resultant quantum state corresponding to each integer k, and the k-th resultant quantum state is obtained by applying stage of the first iteration on the basis of the (k−1)-th resultant quantum state.

Stat 105: computing a zero-noise expected value of an ideal quantum device corresponding to the actual quantum device based on the intermediate quantum state and a resultant quantum state obtained through each applying stage of the first iteration.

In the present embodiment, one resultant quantum state is obtained through each applying stage of the first iteration, K resultant quantum states are obtained by performing a first iteration of applying the noise channel to the intermediate quantum for K times, K being equal to the value of the truncation coefficient, and each resultant quantum state among the K resultant quantum states is obtained on the basis of a previous resultant quantum state.

In the present embodiment, the intermediate quantum state to the resultant quantum state obtained through the last applying stage of the first iteration are all noise quantum states, and computed zero-noise expected values may be different based on different values of the truncation coefficient. In addition, the higher a value of the truncation coefficient (the truncation coefficient has only a minimum value) is, the louder the obtained quantum noise is, and the louder the noise is, the more truly the noisy expected value of the actual quantum device may be reflected.

In some alternative implementations of the present embodiment, the computing the zero-noise expected value of the ideal quantum device corresponding to the actual quantum device based on the intermediate quantum state and the resultant quantum state obtained through each applying stage of the first iteration includes: computing noisy expected values based on the intermediate quantum state and the resultant quantum states obtained through the first iteration, and computing an unbiased estimate of the zero-noise expected value of the ideal quantum device corresponding to the actual quantum device using the Neumann series based on noisy expected values corresponding to all of the resultant quantum states and a noisy expected value corresponding to the intermediate quantum state.

In the present alternative implementation, the unbiased estimate of the zero-noise expected value is an estimate value of the zero-noise expected value, and an absolute value of a difference between the unbiased estimate of the zero-noise expected value and the zero-noise expected value is less than or equal to the current error tolerance.

In the present alternative implementation, as shown in FIG. 2, the noise channel b of the actual quantum device is invoked for a plurality of times to compute noisy expected values of different noise levels, and finally the noisy expected values are used to reversely infer the zero-noise expected value of the ideal quantum device Tr[Oρ]. Therefore, there is no dependence on redundant auxiliary qubits, no need for adjusting a Hamiltonian at a hardware level, no dependence on the number of qubits, and no assumptions about a noise model of a noisy quantum circuit thereby improving the universality of the denoising process of an actual quantum device, and guaranteeing the denoising effects of the actual quantum device.

The method for denoising a quantum device provided in the embodiments of the present disclosure first acquires a noise channel of an actual quantum device; then determines a truncation coefficient based on the noise channel, the truncation coefficient being used for characterizing the number of expanded items of a Neumann series of the noise channel at a current error tolerance; then runs the actual quantum device to generate an intermediate quantum state; then performing a first iteration of applying the noise channel on the intermediate quantum state for the number of times, the number of times being equal to a value of the truncation coefficient, each applying stage of the first iteration being performed based on a result of a previous applying stage of the first iteration; and finally computes a zero-noise expected value of an ideal quantum device corresponding to the actual quantum device based on the intermediate quantum state and a resultant quantum state obtained through each applying stage of the first iteration. The embodiments of the present disclosure are suitable for any quantum device capable of generating a quantum state, and do not rely on a means, such as, a noise model. Although a noisy quantum gate is repeatedly used in a computing process, an obtained truncation coefficient is generally small in practice, and therefore, the noisy quantum gate is repeatedly used for only a few times, thus providing good universality. The present embodiment does not rely on qubit data and thus provides better expansibility. In the near future, the quantum device may have a wider range of use. The present embodiment can compute a zero-noise expected value of an ideal quantum device corresponding to the quantum device, as long as a noise channel of a quantum device is maintained within a reasonable range, thereby providing high practicability.

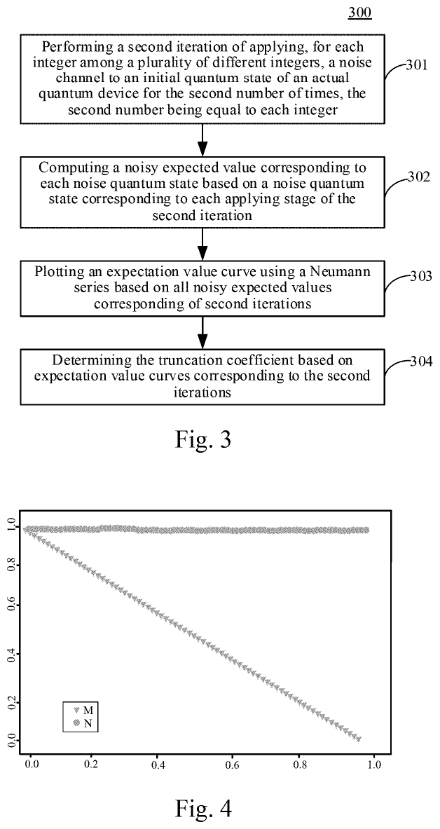

FIG. 3 shows a flowchart 300 of a method for obtaining a truncation coefficient according to an embodiment of the present disclosure. The method for obtaining a truncation coefficient includes the following steps:

Step 301: performing a second iteration of applying, for each integer among a plurality of different integers, a noise channel to an initial quantum state of an actual quantum device for the second number of times, the second number being equal to each integer.

Each applying stage of the second iteration is performed based on a result of a previous applying stage of the second iteration, so that a noise quantum state corresponding to each applying stage of the second iteration is obtained.

In the present alternative implementation, the initial quantum state of the actual quantum device is an initial quantum state outputted by the actual quantum device after the actual quantum device is run once, and the initial quantum state may be a quantum state outputted by the actual quantum device in an experimental scenario (which is different from the scenario where the method for denoising a quantum device of some embodiments of the present disclosure is run). A truncation coefficient corresponding to the actual quantum device may be obtained experimentally based on the initial quantum state.

In the present alternative implementation, the performing a second iteration of applying, for each integer among the plurality of different integers, the noise channel to the initial quantum state of the actual quantum device for the second number of times, the number being equal to each integer may include: performing a second iteration of applying the noise channel to the initial quantum state for the number of times, the number being equal to a first integer, performing a second iteration of applying the noise channel to the initial quantum state for the number of times, the number being equal to a second integer, and performing a second iteration of applying the noise channel to the initial quantum state for the number of times, the number being equal to a last integer. A second iteration of applying the noise channel to the initial quantum state for the number of times, the number being equal to an integer, to obtain noise quantum states corresponding to the number of steps of applying stage of the second iteration, the number being equal to the integer.

Step 302: computing a noisy expected value corresponding to each noise quantum state based on a noise quantum state corresponding to each applying stage of the second iteration.

In the present alternative implementation, the number of the applying stage of the second iteration is equal to the integer for each iteration; for example, if a current integer is 5, 5 applying stages are performed, each applying stage corresponds to a noise quantum state, and 5 applying stages are completed, that is, one iteration is completed.

Step 303: plotting an expectation value curve using a Neumann series based on all noisy expected values of second iterations.

In the present embodiment, each iteration corresponds to the number of applying stages, the number being equal to a current integer. When the number of applying stages, the number being equal to the current integer, is completed, noisy expected values are obtained, where the number of the noisy expected values is equal to the current integer. Each iteration corresponds to one expectation value curve, and each integer corresponds to one expectation value curve.

The expectation value curve is a curve plotted by superimposing all noisy expected values under a current function based on the Neumann series.

In the present embodiment, all of the noisy expected values under the current function are superimposed using the Neumann series based on weights, and oscillate within positive and negative ranges of the zero-noise expected value. When the number of noisy expected values is enough (the number of items is K+1), the oscillation curve will converge, and the convergence value corresponds to the zero-noise expected value.

Step 304: determining the truncation coefficient based on expectation value curves corresponding to second iterations.

In the present alternative implementation, based on the expectation value curves corresponding to the second iterations, a converging expectation value curve may be determined, and an integer corresponding to the converging expectation value curve is the truncation coefficient.

In the present alternative implementation, an expectation value curve of noisy expected values corresponding to second iterations is determined using numbers of applying stages of the second iteration, the numbers being equal to a plurality of the integer, and the truncation coefficient is determined based on a plurality of expectation value curves, thereby accurately determining the truncation coefficient by experimental means, and guaranteeing the denoising effects of the quantum device in real time.

In some alternative implementations of the present embodiment, the determining the truncation coefficient based on the expectation value curves corresponding to second iterations includes: determining a convergence curve among all expectation value curves corresponding to all second iterations; and using an integer corresponding to any one of the convergence curve as the truncation coefficient.

The number of iterations is completely different from the number of applying stages. One iteration corresponds to one expectation value curve, and each integer corresponds to one iteration. An expectation value curve obtained based on the Neumann series starts to converge (i.e., a convergence curve) when an integer is large enough, and an integer corresponding to each convergence curve may be used as a truncation coefficient.

In the present alternative implementation, an integer corresponding to a convergence curve is selected to conveniently and quickly obtain the truncation coefficient, thereby providing a reliable embodiment for obtaining the truncation coefficient.

The method for denoising a quantum device provided in the present embodiment is the most general form of extracting classical information by quantum computing, and has a wide range of applications. For example, a typical application scenario includes an algorithm running on a recent quantum computer, such as VQE and a quantum approximate optimization algorithm (QAOA).

In some alternative implementations of the present embodiment, the actual quantum device is a quantum processor of a quantum eigensolver algorithm, and the zero-noise expected value is a zero-noise expected value corresponding to the quantum processor of the quantum eigensolver algorithm.

In the present alternative implementation, the method for denoising a quantum device of the present embodiment is used through the quantum processor of the quantum eigensolver algorithm, thereby effectively removing the noise of the quantum processor of the quantum eigensolver algorithm, obtaining the zero-noise expected value corresponding to the quantum processor of the quantum eigensolver algorithm, and improving the denoising effects of the VQE quantum device.

In order to better show the effects of some embodiments of the present disclosure, the denoising effects of the quantum device are illustrated below, e.g., by taking an instance as an example.

As an instance in a single-qubit system, it is assumed that a state generated by an ideal quantum device is ρ=|0><0| (a ground state of the system), an observation operator is a Pauli Z operator, and an ideal expectation value is Tr[Zρ]=1. It is assumed that a quantum noise is a depolarized quantum channel Ωₚ (0≤p≤1), which is defined as

Ωₚ(ρ)=(1−p)*ρ+p*I/2 (4)

In the equation (4), I is an identity matrix of 2×2. If the noise is not processed, a noisy expected value corresponding to the intermediate quantum state is obtained as Tr[ZΩₚ(ρ)]=1−p.

Using the method for denoising a quantum device of the present embodiment, ∥<<Z|∥_{∞}=1 may be obtained by computation, and ∥[1]−[Ωₚ (ρ)]∥_{∞}=p. An error tolerance is set as ε=0.01, and a corresponding truncation coefficient K is expressed as

$$K = ⌈ - \frac{2}{{log}_{10} p} - 1 ⌉$$

After computing these relevant parameters, error is processed, and E* outputted on the basis of the solution is recorded as the processed expectation value. As shown in FIG. 4, a variation diagram of a noisy expected value N and a processed zero-noise expected value M varying with a noise parameter p is shown. In FIG. 4, the horizontal axis denotes the noise parameter p, and the longitudinal axis denotes an expectation value. As can be obviously observed from FIG. 4, compared with the noisy expected values, the method for denoising a quantum device of the present embodiment significantly improves the accuracy of the obtained expectation values, and the zero-noise expected value N after noise processing extremely accurately approximates an ideal expectation value 1.

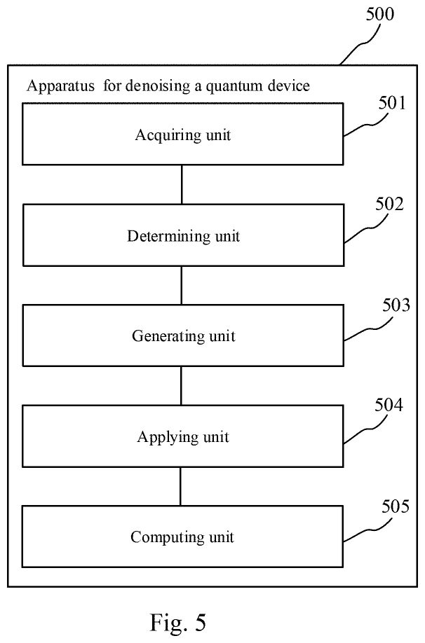

Further referring to FIG. 5, as an implementation of the method shown in the above figures, an embodiment of the present disclosure provides an apparatus for denoising a quantum device. The embodiment of the apparatus corresponds to the embodiment of the method shown in FIG. 1, and the apparatus may be specifically applied to various electronic devices.

As shown in FIG. 5, the apparatus 500 for denoising a quantum device provided in the present embodiment includes: an acquiring unit 501, a determining unit 502, a generating unit 503, an applying 504, and a computing unit 505. The acquiring unit 501 may be configured to acquire a noise channel of an actual quantum device. The determining unit 502 may be configured to determine a truncation coefficient based on the noise channel, the truncation coefficient being used for characterizing a number of expanded items of a Neumann series of the noise channel at a current error tolerance. The generating unit 503 may be configured to run the actual quantum device to generate an intermediate quantum state. The applying unit 504 may be configured to perform a first iteration of applying the noise channel to the intermediate quantum state for the number of times, the number being equal to a value of the truncation coefficient, each applying stage of the first iteration being performed based on a result of a previous applying stage of the first iteration. The computing unit 505 may be configured to compute a zero-noise expected value of an ideal quantum device corresponding to the actual quantum device based on the intermediate quantum state and a resultant quantum state obtained through each applying stage of the first iteration.

In the present embodiment, the specific processing of the acquiring unit 501, the determining unit 502, the generating unit 503, the applying unit 504, and the computing unit 505 of the apparatus 500 for denoising a quantum device in the present embodiment and the technical effects thereof may be described with reference to the relevant description of step 101, step 102, step 103, step 104 and step 105 in the corresponding embodiment of FIG. 1, respectively, and are not repeated here.

In some alternative implementations of the present embodiment, the acquiring unit is further configured to acquire the noise channel of the actual quantum device by a quantum process tomography or a quantum gate set chromatography.

In some alternative implementations of the present embodiment, the truncation coefficient is denoted by K and is determined based on the following equation:

$$K \geq ⌈ \frac{log ɛ - log ‖ ⪡ O ‖ {\vert}_{∞}}{log {‖ I - [ 𝒩 ] ‖}_{∞}} - 1 ⌉$$

where O is an observation operator symbol, <<O| is a Pauli transfer matrix of O, I is a unit matrix, ∥ ∥_{∞} represents an infinite norm, ┌.┐ represents rounding up, [symbol] is the noise channel, [ [symbol] ] is a Pauli transfer matrix of [symbol] , and ε is the current error tolerance.

In some alternative implementations of the present embodiment, the determining unit 502 includes an obtaining module (not shown in the figure), an expectation value computing module (not shown in the figure), a plotting module (not shown in the figure), and a positioning module (not shown in the figure). The obtaining module may be configured to perform a second iteration of applying, for each integer among a plurality of different integers, the noise channel to an initial quantum state of the actual quantum device for the second number of times, to obtain a noise quantum state corresponding to each applying stage of the second iteration, the second number being equal to each integer, and each applying stage of the second iteration being performed based on the result of the previous applying stage of the second iteration. The expectation value computing module may be configured to compute a noisy expected value corresponding to each noise quantum state based on the noise quantum state corresponding to each applying stage of the second iteration. The plotting module may be configured to plot an expectation value curve using the Neumann series based on all noisy expected values of second iterations. The positioning module may be configured to determine the truncation coefficient based on expectation value curves corresponding to second iterations.

In some alternative implementations of the present embodiment, the positioning module includes: a determining submodule (not shown in the figure) and a functioning submodule (not shown in the figure). The determining submodule may be configured to determine a convergence curve among all expectation value curves corresponding to all second iterations. The functioning submodule may be configured to use an integer corresponding to any one of the convergence curve as the truncation coefficient.

In some alternative implementations of the present embodiment, the computing unit 505 includes: a noisy expected value computing module (not shown in the figure) and a zero-noise expected value computing module (not shown in the figure). The noisy expected value computing module may be configured to compute the noisy expected values based on the intermediate quantum state and the resultant quantum state obtained through each applying stage of the first iteration. The zero-noise expected value computing module may be configured to compute an unbiased estimate of the zero-noise expected value of the ideal quantum device corresponding to the actual quantum device using the Neumann series based on noisy expected values corresponding to all resultant quantum states and a noisy expected value corresponding to the intermediate quantum state.

In some alternative implementations of the present embodiment, the actual quantum device is a quantum processor of a quantum eigensolver algorithm, and the zero-noise expected value is a zero-noise expected value corresponding to the quantum processor of the quantum eigensolver algorithm.

In the apparatus for denoising a quantum device provided in the embodiments of the present disclosure, first, the acquiring unit 501 acquires a noise channel of an actual quantum device; then, the determining unit 502 determines a truncation coefficient based on the noise channel, the truncation coefficient being used for characterizing the number of expanded items of a Neumann series of the noise channel at a current error tolerance; then, the generating unit 503 runs the actual quantum device to generate an intermediate quantum state; then, the applying unit 504 iteratively functions the noise channel on the intermediate quantum state for the number of times, the number of times being equal to a value of the truncation coefficient, each iteration being performed based on a result of a previous iteration; and finally, the computing unit 505 computes a zero-noise expected value of an ideal quantum device corresponding to the actual quantum device based on the intermediate quantum state and a resultant quantum state obtained through each iteration. The embodiments of the present disclosure are suitable for any quantum device capable of generating a quantum state and do noy rely on a means, such as, a noise model. Although a noisy quantum gate is repeatedly used in a computing process, an obtained truncation coefficient is generally small in practice, and therefore, the noisy quantum gate is repeatedly used for only a few times, thus providing good universality. The present embodiment does not rely on qubit data and thus provides better expansibility, and can be widely used in the quantum device. The present embodiment can compute a zero-noise expected value of an ideal quantum device corresponding to the quantum device, as long as a noise channel of a quantum device is maintained within a reasonable range, thereby providing high practicability.

According to an embodiment of the present disclosure, the present disclosure further provides an electronic device, a readable storage medium, and a computer program product.

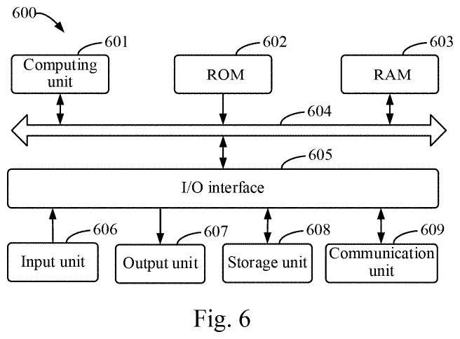

FIG. 6 shows a schematic block diagram of an example electronic device 600 that may be configured to implement embodiments of the present disclosure. The electronic device is intended to represent various forms of digital computers, such as a laptop computer, a desktop computer, a workbench, a personal digital assistant, a server, a blade server, a mainframe computer, and other suitable computers. The electronic device may alternatively represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 6, the device 600 includes a computing unit 601, which may execute various appropriate actions and processes in accordance with a computer program stored in a read-only memory (ROM) 602 or a computer program loaded into a random access memory (RAM) 603 from a storage unit 608. The RAM 603 may further store various programs and data required by operations of the device 600. The computing unit 601, the ROM 602, and the RAM 603 are connected to each other through a bus 604. An input/output (I/O) interface 605 is also connected to the bus 604.

A plurality of components in the device 600 is connected to the I/O interface 605, including: an input unit 606, such as a keyboard and a mouse; an output unit 607, such as various types of displays and speakers; a storage unit 608, such as a magnetic disk and an optical disk; and a communication unit 609, such as a network card, a modem, and a wireless communication transceiver. The communication unit 609 allows the device 600 to exchange information/data with other devices through a computer network such as the Internet and/or various telecommunication networks.

The computing unit 601 may be various general purpose and/or specific purpose processing components having a processing capability and a computing capability. Some examples of the computing unit 601 include, but are not limited to, a central processing unit (CPU), a graphics processing unit (GPU), various specific purpose artificial intelligence (AI) computing chips, various computing units running a machine learning model algorithm, a digital signal processor (DSP), and any appropriate processor, controller, micro-controller, and the like. The computing unit 601 executes various methods and processes described above, such as the method for denoising a quantum device. For example, in some embodiments, the method for denoising a quantum device may be implemented as a computer software program that is tangibly included in a machine readable medium, such as the storage unit 608. In some embodiments, some or all of the computer programs may be loaded and/or installed onto the device 600 via the ROM 602 and/or the communication unit 609. When the computer program is loaded into the RAM 603 and executed by the computing unit 601, one or more steps of the method for denoising a quantum device described above may be executed. Alternatively, in other embodiments, the computing unit 601 may be configured to execute the method for denoising a quantum device by any other appropriate approach (e.g., by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include: being implemented in one or more computer programs, where the one or more computer programs may be executed and/or interpreted on a programmable system including at least one programmable processor, and the programmable processor may be a specific-purpose or general-purpose programmable processor, which may receive data and instructions from a storage system, at least one input apparatus and at least one output apparatus, and send the data and instructions to the storage system, the at least one input apparatus and the at least one output apparatus.

Program codes for implementing the method of some embodiments of the present disclosure may be compiled using any combination of one or more programming languages. The program codes may be provided to a processor or controller of a general purpose computer, a specific purpose computer, or other programmable apparatuses for denoising a quantum device, such that the program codes, when executed by the processor or controller, cause the functions/operations specified in the flowcharts and/or block diagrams to be implemented. The program codes may be completely executed on a machine, partially executed on a machine, partially executed on a machine and partially executed on a remote machine as a separate software package, or completely executed on a remote machine or server.

In the context of some embodiments of the present disclosure, the machine readable medium may be a tangible medium which may contain or store a program for use by, or used in combination with, an instruction execution system, apparatus or device. The machine readable medium may be a machine readable signal medium or a machine readable storage medium. The computer-readable medium may include, but is not limited to, electronic, magnetic, optical, electromagnetic, infrared, or semiconductor systems, apparatuses, or devices, or any appropriate combination of the above. A more specific example of the machine readable storage medium will include an electrical connection based on one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or tactile feedback); and an input may be received from the user in any form (including an acoustic input, a voice input, or a tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other.

In the technical solution of some embodiments of the present disclosure, the acquisition, storage, and application of involved user personal information are in conformity with relevant laws and regulations, and do not violate public order and good customs.

It should be understood that the various forms of processes shown above may be used to reorder, add, or delete steps. For example, the steps disclosed in the present disclosure may be executed in parallel, sequentially, or in different orders, as long as the desired results of the technical solutions disclosed in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for denoising a quantum device, comprising:
acquiring a noise channel of an actual quantum device;
determining a truncation coefficient based on the noise channel, the truncation coefficient being used for characterizing a number of expanded items of a Neumann series of the noise channel at a current error tolerance;
running the actual quantum device to generate an intermediate quantum state;
performing a first iteration of applying the noise channel to the intermediate quantum state for a number of times, the number being equal to a value of the truncation coefficient, each applying stage of the first iteration being performed based on a result of a previous applying stage of the first iteration; and
computing a zero-noise expected value of an ideal quantum device corresponding to the actual quantum device based on the intermediate quantum state and a resultant quantum state obtained through the each applying stage of the first iteration.

2. The method according to claim 1, wherein the acquiring the noise channel of the actual quantum device comprises:
acquiring the noise channel of the actual quantum device by a quantum process tomography or a quantum gate set chromatography.

3. The method according to claim 1, wherein the truncation coefficient is denoted by K, and is determined based on an equation as follows:
$$K \geq ⌈ \frac{log ɛ - log ‖ ⪡ O ‖ {\vert}_{∞}}{log {‖ I - [ 𝒩 ] ‖}_{∞}} - 1 ⌉$$
wherein O is an observation operator symbol, <<O| is a Pauli transfer matrix of O, I is a unit matrix, ∥ ∥_{∞} represents an infinite norm, ┌.┐ represents rounding up, [symbol] is the noise channel, [ [symbol] ] is a Pauli transfer matrix of [symbol] , and ε is the current error tolerance.

4. The method according to claim 1, wherein the determining the truncation coefficient based on the noise channel comprises:
performing a second iteration of applying, for each integer among a plurality of different integers, the noise channel to an initial quantum state of the actual quantum device for a second number of times, to obtain a noise quantum state corresponding to each applying stage of the second iteration, the second number being equal to the each integer, and each applying stage of the second iteration being performed based on a result of a previous applying stage of the second iteration;
computing a noisy expected value corresponding to each noise quantum state based on the noise quantum state corresponding to the each applying stage of the second iteration;
plotting an expectation value curve using the Neumann series based on all noisy expected values corresponding to second iterations; and
determining the truncation coefficient based on an expectation value curves corresponding to the second iterations.

5. The method according to claim 4, wherein the determining the truncation coefficient based on the expectation value curve corresponding to the second iterations comprises:
determining a convergence curve among all expectation value curves corresponding to all second iterations; and
using an integer corresponding to any one of the convergence curve as the truncation coefficient.

6. The method according to claim 1, wherein the computing the zero-noise expected value of the ideal quantum device corresponding to the actual quantum device based on the intermediate quantum state and the resultant quantum state obtained through the each applying stage of the first iteration comprises:
computing noisy expected values based on the intermediate quantum state and the resultant quantum state obtained through the each applying stage of the first iteration; and
computing an unbiased estimate of the zero-noise expected value of the ideal quantum device corresponding to the actual quantum device using the Neumann series based on noisy expected values corresponding to all resultant quantum states and a noisy expected value corresponding to the intermediate quantum state.

7. The method according to claim 2, wherein the computing the zero-noise expected value of the ideal quantum device corresponding to the actual quantum device based on the intermediate quantum state and the resultant quantum state obtained through the each applying stage of the first iteration comprises:
computing noisy expected values based on the intermediate quantum state and the resultant quantum state obtained through the each applying stage of the first iteration; and
computing an unbiased estimate of the zero-noise expected value of the ideal quantum device corresponding to the actual quantum device using the Neumann series based on noisy expected values corresponding to all resultant quantum states and a noisy expected value corresponding to the intermediate quantum state.

8. The method according to claim 3, wherein the computing the zero-noise expected value of the ideal quantum device corresponding to the actual quantum device based on the intermediate quantum state and the resultant quantum state obtained through the each applying stage of the first iteration comprises:
computing noisy expected values based on the intermediate quantum state and the resultant quantum state obtained through the each applying stage of the first iteration; and
computing an unbiased estimate of the zero-noise expected value of the ideal quantum device corresponding to the actual quantum device using the Neumann series based on noisy expected values corresponding to all resultant quantum states and a noisy expected value corresponding to the intermediate quantum state.

9. The method according to claim 4, wherein the computing the zero-noise expected value of the ideal quantum device corresponding to the actual quantum device based on the intermediate quantum state and the resultant quantum state obtained through the each applying stage of the first iteration comprises:
computing noisy expected values based on the intermediate quantum state and the resultant quantum state obtained through the each applying stage of the first iteration; and
computing an unbiased estimate of the zero-noise expected value of the ideal quantum device corresponding to the actual quantum device using the Neumann series based on noisy expected values corresponding to all resultant quantum states and a noisy expected value corresponding to the intermediate quantum state.

10. The method according to claim 5, wherein the computing the zero-noise expected value of the ideal quantum device corresponding to the actual quantum device based on the intermediate quantum state and the resultant quantum state obtained through the each applying stage of the first iteration comprises:
computing noisy expected values based on the intermediate quantum state and the resultant quantum state obtained through the each applying stage of the first iteration; and
computing an unbiased estimate of the zero-noise expected value of the ideal quantum device corresponding to the actual quantum device using the Neumann series based on noisy expected values corresponding to all resultant quantum states and a noisy expected value corresponding to the intermediate quantum state.

11. The method according to claim 6, wherein the actual quantum device is a quantum processor of a quantum eigensolver algorithm, and the zero-noise expected value is a zero-noise expected value corresponding to the quantum processor of the quantum eigensolver algorithm.

12. An electronic device, comprising:
at least one processor; and
a memory communicatively connected to the at least one processor; wherein
the memory stores instructions executable by the at least one processor, and the instructions, when executed by the at least one processor, cause the at least one processor to perform operations comprising:
acquiring a noise channel of an actual quantum device;
determining a truncation coefficient based on the noise channel, the truncation coefficient being used for characterizing a number of expanded items of a Neumann series of the noise channel at a current error tolerance;
running the actual quantum device to generate an intermediate quantum state;
performing a first iteration of applying the noise channel to the intermediate quantum state for a number of times, the number being equal to a value of the truncation coefficient, each applying stage of the first iteration being performed based on a result of a previous applying stage of the first iteration; and
computing a zero-noise expected value of an ideal quantum device corresponding to the actual quantum device based on the intermediate quantum state and a resultant quantum state obtained through the each applying stage of the first iteration.

13. The electronic device according to claim 12, wherein the acquiring the noise channel of the actual quantum device comprises:
acquiring the noise channel of the actual quantum device by a quantum process tomography or a quantum gate set chromatography.

14. The electronic device according to claim 12, wherein the truncation coefficient is denoted by K, and is determined based on an equation as follows:
$$K \geq ⌈ \frac{log ɛ - log ‖ ⪡ O ‖ {\vert}_{∞}}{log {‖ I - [ 𝒩 ] ‖}_{∞}} - 1 ⌉$$
wherein O is an observation operator symbol, <<O| is a Pauli transfer matrix of O, I is a unit matrix, ∥ ∥_{∞} represents an infinite norm, ┌.┐ represents rounding up, [symbol] is the noise channel, [ [symbol] ] is a Pauli transfer matrix of [symbol] , and ε is the current error tolerance.

15. The electronic device according to claim 12, wherein the determining the truncation coefficient based on the noise channel comprises:
performing a second iteration of applying, for each integer among a plurality of different integers, the noise channel to an initial quantum state of the actual quantum device for a second number of times, to obtain a noise quantum state corresponding to each applying stage of the second iteration, the second number being equal to the each integer, and each applying stage of the second iteration being performed based on a result of a previous applying stage of the second iteration;
computing a noisy expected value corresponding to each noise quantum state based on the noise quantum state corresponding to the each applying stage of the second iteration;
plotting an expectation value curve using the Neumann series based on all noisy expected values corresponding to second iterations; and
determining the truncation coefficient based on an expectation value curves corresponding to the second iterations.

16. The electronic device according to claim 15, wherein the determining the truncation coefficient based on the expectation value curve corresponding to the second iterations comprises:
determining a convergence curve among all expectation value curves corresponding to all second iterations; and
using an integer corresponding to any one of the convergence curve as the truncation coefficient.

17. The electronic device according to claim 12, wherein the computing the zero-noise expected value of the ideal quantum device corresponding to the actual quantum device based on the intermediate quantum state and the resultant quantum state obtained through the each applying stage of the first iteration comprises:
computing noisy expected values based on the intermediate quantum state and the resultant quantum state obtained through the each applying stage of the first iteration; and
computing an unbiased estimate of the zero-noise expected value of the ideal quantum device corresponding to the actual quantum device using the Neumann series based on noisy expected values corresponding to all resultant quantum states and a noisy expected value corresponding to the intermediate quantum state.

18. The electronic device according to claim 13, wherein the computing the zero-noise expected value of the ideal quantum device corresponding to the actual quantum device based on the intermediate quantum state and the resultant quantum state obtained through the each applying stage of the first iteration comprises:
computing noisy expected values based on the intermediate quantum state and the resultant quantum state obtained through the each applying stage of the first iteration; and
computing an unbiased estimate of the zero-noise expected value of the ideal quantum device corresponding to the actual quantum device using the Neumann series based on noisy expected values corresponding to all resultant quantum states and a noisy expected value corresponding to the intermediate quantum state.

19. The electronic device according to claim 17, wherein the actual quantum device is a quantum processor of a quantum eigensolver algorithm, and the zero-noise expected value is a zero-noise expected value corresponding to the quantum processor of the quantum eigensolver algorithm.

20. A non-transitory computer-readable storage medium storing computer instructions, wherein the computer instructions are used for causing a computer to perform operations comprising:
acquiring a noise channel of an actual quantum device;
determining a truncation coefficient based on the noise channel, the truncation coefficient being used for characterizing a number of expanded items of a Neumann series of the noise channel at a current error tolerance;
running the actual quantum device to generate an intermediate quantum state;
performing a first iteration of applying the noise channel to the intermediate quantum state for a number of times, the number being equal to a value of the truncation coefficient, each applying stage of the first iteration being performed based on a result of a previous applying stage of the first iteration; and
computing a zero-noise expected value of an ideal quantum device corresponding to the actual quantum device based on the intermediate quantum state and a resultant quantum state obtained through the each applying stage of the first iteration.
